(19) United States
(12) Patent Application Publication
(10) Pub. No.: US 2026/0001194 A1
(43) Pub. Date: Jan. 1, 2026

(54) PAD-SURFACE DETERMINATION METHOD AND PAD-SURFACE DETERMINATION SYSTEM

(71) Applicant: EBARA CORPORATION, Tokyo (JP)

(72) Inventors: Toshifumi KIMBA, Tokyo (JP); Kohei OHSHIMA, Tokyo (JP)

(21) Appl. No.: 19/247,279

(22) Filed: Jun. 24, 2025

(30) Foreign Application Priority Data
Jun. 27, 2024 (JP) 2024-103655

(51) Int. Cl. B24B 49/12; B24B 37/24; G06T 7/00

(52) U.S. Cl. CPC B24B 49/12; B24B 37/24; G06T 7/0004; G06T 2207/30164

(57) ABSTRACT

A pad-surface determination method that can appropriately determine a surface property of a polishing pad including a condition of protrusions formed on a polishing surface of the polishing pad is disclosed. The pad-surface determination method includes: irradiating a target area in the polishing surface with a plurality of lights from a plurality of light emitters at different incident angles; receiving a plurality of reflected lights from the target area by an imaging device; generating a plurality of images corresponding to the different incident angles by the imaging device; and determining the surface property of the polishing pad based on at least one of the plurality of images. A protrusion is formed on the polishing surface in the target area.

### CROSS REFERENCE TO RELATED APPLICATION

This document claims priority to Japanese Patent Application No. 2024-103655 filed Jun. 27, 2024, the entire contents of which are hereby incorporated by reference.

### BACKGROUND

In manufacturing process of semiconductor devices, planarization of surfaces of the semiconductor devices is becoming increasingly important. The most important technique for planarizing the surfaces is chemical mechanical polishing (CMP). Chemical mechanical polishing (hereinafter referred to as CMP) is a process of polishing a substrate, such as a wafer, by bringing the substrate into sliding contact with a polishing surface of the polishing pad while supplying a polishing liquid containing abrasive grains, such as silica (SiO₂) onto the polishing surface of the polishing pad.

A polishing apparatus for performing CMP includes a polishing table that supports the polishing pad having the polishing surface, and a polishing head that presses the substrate against the polishing pad. The polishing apparatus polishes the substrate as follows. While the polishing table and polishing pad are rotated together, the polishing liquid (typically slurry) is supplied onto the polishing surface of the polishing pad. The polishing head presses the surface of the substrate against the polishing surface of the polishing pad while rotating the substrate. The substrate is brought into sliding contact with the polishing pad in the presence of the polishing liquid. The surface of the substrate is polished by a chemical action of the polishing liquid and a mechanical action of abrasive grains contained in the polishing liquid and/or the polishing pad.

As the substrate is polished, the abrasive grains and polishing debris adhere to the polishing surface of the polishing pad, resulting in a decrease in polishing performance of the polishing surface of the polishing pad. Therefore, in order to regenerate the polishing surface of the polishing pad, dressing (conditioning) of the polishing pad is performed using a dresser. The dresser has hard abrasive grains, such as diamond particles, fixed to its lower surface. The dresser scrapes the polishing surface of the polishing pad to thereby regenerate the polishing surface of the polishing pad.

The polishing pad gradually wears as polishing of a substrate and dressing of the polishing pad are repeated. When the polishing pad wears, the polishing pad cannot provide its intended polishing performance. Therefore, it is necessary to periodically replace the polishing pad with a new one. Specifically, when a use time of the polishing pad exceeds a predetermined time, or when the number of polished substrates exceeds a predetermined number, the polishing pad is replaced with a new one.

However, the use time of the polishing pad and the number of polished substrates indirectly represent the wear of the polishing pad, and may not appropriately reflect the wear of the polishing pad. Therefore, a polishing pad that has not yet reached an end of its service life may be replaced, or a polishing pad that has worn out beyond its use limit may continue to be used.

A service life of a polishing pad is affected not only by wear of the polishing pad, but also by minute protrusions formed on a polishing surface of the polishing pad. Such protrusions provide a surface roughness of the polishing pad. When the protrusions become small (i.e., when the surface roughness of the polishing pad decreases), a polishing rate (which may be referred to as removal rate) of a substrate may decrease.

### SUMMARY

Therefore, there is provided a pad-surface determination method and a pad-surface determination system that can appropriately determine a surface property (or surface condition) of a polishing pad including a condition of protrusions formed on a polishing surface of the polishing pad.

Embodiments, which will be described below, relate to a pad-surface determination method and a pad-surface determination system for determining a surface property of a polishing pad for polishing a substrate, such as a wafer.

In an embodiment, there is provided a pad-surface determination method of determining a surface property of a polishing pad having a polishing surface for polishing a substrate, comprising: irradiating a target area in the polishing surface with a plurality of lights from a plurality of light emitters at different incident angles, a protrusion being formed on the polishing surface in the target area; receiving a plurality of reflected lights from the target area by an imaging device; generating a plurality of images corresponding to the different incident angles by the imaging device; and determining the surface property of the polishing pad based on at least one of the plurality of images.

In an embodiment, determining the surface property of the polishing pad comprises generating a pad-surface index value from the at least one image.

In an embodiment, generating the pad-surface index value from the at least one image comprises: creating a differential image or division image from the plurality of images; and calculating the pad-surface index value based on brightness information of the differential image or division image.

In an embodiment, the plurality of lights from the plurality of light emitters include a first light having a wavelength within a first wavelength range emitted from a first light emitter, and a second light having a wavelength within a second wavelength range emitted from a second light emitter, and the first wavelength range is different from the second wavelength range.

In an embodiment, the first light emitter and the second light emitter simultaneously irradiate the target area with the first light and the second light at the different incident angles.

In an embodiment, the plurality of images corresponding to the different incident angles are simultaneously generated by the imaging device.

In an embodiment, the pad-surface determination method further comprises repeating irradiation of the target area with the plurality of lights and generation of a plurality of images from a plurality of reflected lights by the imaging device to obtain a plurality of time-differential images of a plurality of groups corresponding to the different incident angles, wherein generating the pad-surface index value comprises generating a differential image or division image from a plurality of time-differential images within a group of the same incident angle, and calculating the pad-surface index value based on brightness information of the differential image or division image.

In an embodiment, the pad-surface determination method further comprises: repeating irradiation of the target area with the plurality of lights, generation of a plurality of images from a plurality of reflected lights by the imaging device, and generation of the pad-surface index value to obtain a plurality of pad-surface index values; and calculating a variance of the plurality of pad-surface index values.

In an embodiment, determining the surface property of the polishing pad based on the at least one image comprises: inputting the at least one image into a determination model constructed by machine learning; and outputting a determination result of the surface property of the polishing pad from the determination model.

In an embodiment, the plurality of lights are emitted from the plurality of light emitters onto the target area through a filter, the filter being configured to allow the plurality of lights to pass therethrough, while not allowing passage of light from a direction different from a direction of the plurality of lights as viewed from a direction perpendicular to the polishing surface.

In an embodiment, the filter has a plurality of light-blocking walls extending parallel to an orientation of the plurality of light emitters as viewed from the direction perpendicular to the polishing surface, and the plurality of light-blocking walls are arranged at intervals.

In an embodiment, generating the pad-surface index value from the at least one image comprises: creating an evaluation image which is either a differential image or a division image from the plurality of images; and calculating the pad-surface index value using brightness values within a permissible range among brightness values of pixels constituting the evaluation image.

In an embodiment, the pad-surface determination method further comprises: creating a frequency distribution of brightness values of pixels constituting the evaluation image; calculating a standard deviation from the frequency distribution; and determining the permissible range from the standard deviation.

In an embodiment, generating the pad-surface index value from the at least one image comprises: correcting the at least one image by removing brightness values outside a permissible range from brightness values of pixels constituting the at least one image; generating an evaluation image, which is either a differential image or a division image, from the plurality of images including the corrected image; and calculating the pad-surface index value using brightness values of pixels constituting the evaluation image.

In an embodiment, the pad-surface determination method further comprises: creating a frequency distribution of brightness values of pixels constituting the at least one image; calculating a standard deviation from the frequency distribution; and determining the permissible range from the standard deviation.

In an embodiment, there is provided a pad-surface determination system for determining a surface property of a polishing pad having a polishing surface for polishing a substrate, comprising: a plurality of light emitters configured to irradiate a target area in the polishing surface with a plurality of lights at different incident angles, a protrusion being formed on the polishing surface in the target area; an imaging device configured to receive a plurality of reflected lights from the target area and generates a plurality of images from the plurality of reflected lights; and a system processing device configured to determine the surface property of the polishing pad based on at least one of the plurality of images.

In an embodiment, the system processing device is configured to generate a pad-surface index value from the at least one image.

In an embodiment, the pad-surface index value is calculated based on brightness information of an image.

In an embodiment, the system processing device is configured to create a differential image or division image from the plurality of images, and calculate the pad-surface index value based on brightness information of the differential image or division image.

In an embodiment, the plurality of light emitters include a first light emitter configured to emit a first light having a wavelength within a first wavelength range, and a second light emitter configured to emit a second light having a wavelength within a second wavelength range, the first wavelength range being different from the second wavelength range.

In an embodiment, the system processing device is configured to instruct the first light emitter and the second light emitter to simultaneously irradiate the target area with the first light and the second light.

In an embodiment, the imaging device is configured to simultaneously generate the plurality of images from first reflected light and second reflected light corresponding to the first light and the second light, respectively.

In an embodiment, the plurality of light emitters include a first set of light emitters and a second set of light emitters, the first set of light emitters being located in a first direction from the target area as viewed from a direction perpendicular to the polishing surface of the polishing pad, and the second set of light emitters being located in a second direction from the target area as viewed from the direction perpendicular to the polishing surface of the polishing pad.

In an embodiment, the system processing device is configured to input the at least one image into a determination model constructed by machine learning and output a determination result of the surface property of the polishing pad from the determination model.

In an embodiment, the pad-surface determination system further comprises a filter disposed between the plurality of light emitters and the polishing surface, the filter being configured to allow the plurality of lights to pass therethrough, while not allowing passage of light from a direction different from a direction of the plurality of lights as viewed from a direction perpendicular to the polishing surface.

In an embodiment, the filter has a plurality of light-blocking walls extending parallel to an orientation of the plurality of light emitters as viewed from the direction perpendicular to the polishing surface, and the plurality of light-blocking walls are arranged at intervals.

In an embodiment, the system processing device is configured to: create an evaluation image which is either a differential image or a division image from the plurality of images; and calculate the pad-surface index value using brightness values within a permissible range among brightness values of pixels constituting the evaluation image.

In an embodiment, the system processing device is configured to: create a frequency distribution of brightness values of pixels constituting the evaluation image; calculate a standard deviation from the frequency distribution; and determine the permissible range from the standard deviation.

In an embodiment, the system processing device is configured to: correct the at least one image by removing brightness values outside a permissible range from brightness values of pixels constituting the at least one image; generate an evaluation image, which is either a differential image or a division image, from the plurality of images including the corrected image; and calculate the pad-surface index value using brightness values of pixels constituting the evaluation image.

In an embodiment, the system processing device is configured to: create a frequency distribution of brightness values of pixels constituting the at least one image; calculate a standard deviation from the frequency distribution; and determine the permissible range from the standard deviation.

The light emitted by the light-emitter is incident on the target area within the polishing surface. As a height of the protrusion present in the target area decreases, the intensity of the reflected light from the target area changes. Therefore, the surface property (or surface condition) of the polishing pad can be accurately determined based on the image generated from the reflected light.

Because the plurality of lights emitted by the plurality of light emitters are directed onto the target area at different incident angles, at least one of the plurality of images generated from the plurality of reflected lights shows a characteristic change according to the change in height of the protrusion, regardless of a type of polishing pad and/or a location on the polishing surface. In order to determine an incident angle of light that can accurately reflect a change in the surface condition of the polishing pad (e.g., a change in the height of the protrusion), it is necessary to use the polishing pad from its initial condition until the end of its service life for each of the different incident angles. According to the above-described embodiments, since the plurality of images are generated from the plurality of reflected lights corresponding to the plurality of incident angles, there is no need for determining an optimal incident angle in advance. Furthermore, the surface condition of the polishing pad can be accurately determined based on at least one of the plurality of images corresponding to different incident angles.

### BRIEF DESCRIPTION OF THE DRAWINGS

FIG. 1 is a plan view showing an embodiment of a polishing apparatus;

FIG. 2 is a side view of the polishing apparatus shown in FIG. 1;

FIG. 3 is a schematic diagram showing an example of a protrusion on a polishing surface of a polishing pad;

FIG. 4A and 4B are diagrams illustrating a manner in which intensity of reflected light changes in accordance with a change in height of the protrusion formed on the polishing surface of the polishing pad;

FIG. 5 is a schematic diagram showing an example of an image in which a brightness changes according to the change in height of the protrusion;

FIG. 6 is a diagram showing an example of a plurality of segment areas that have been set within an image;

FIG. 7 is a diagram showing an example of a first area and a second area that have been set within an image;

FIG. 8 is a diagram showing an example of a pad area and a reference area appearing in an image;

FIG. 9 is a side view showing another embodiment of the pad-surface determination system;

FIG. 10 is a graph showing an example of a pad-surface index value that changes with a use time of the polishing pad;

FIG. 11 is a schematic diagram showing an example of three images generated from first reflected light, second reflected light, and third reflected light corresponding to three lights of different incident angles;

FIG. 12 is a schematic diagram showing an example of a differential image generated from two of the three images shown in FIG. 11;

FIG. 13 is a schematic diagram showing an example of a black spot and a white pattern on an image;

FIG. 14 is a diagram showing an example of frequency distribution;

FIG. 15 is a side view showing still another embodiment of the pad-surface determination system;

FIG. 16 is a plan view of the pad-surface determination system shown in FIG. 15;

FIG. 17 is a side view showing still another embodiment of the pad-surface determination system;

FIG. 18 is a schematic diagram showing an example of a determination model constructed using a deep learning method;

FIG. 19 is a side view showing still another embodiment of the pad-surface determination system;

FIG. 20 is a plan view showing an embodiment of a plurality of light emitters and a filter as viewed from a direction perpendicular to a polishing surface;

FIG. 21 is a front view of an embodiment of the plurality of light emitters and the filter; and

FIG. 22 is a diagram illustrating an embodiment of a pitch and a height of light- blocking walls of the filter.

### DESCRIPTION OF EMBODIMENTS

Hereinafter, embodiments will be described with reference to the drawings.

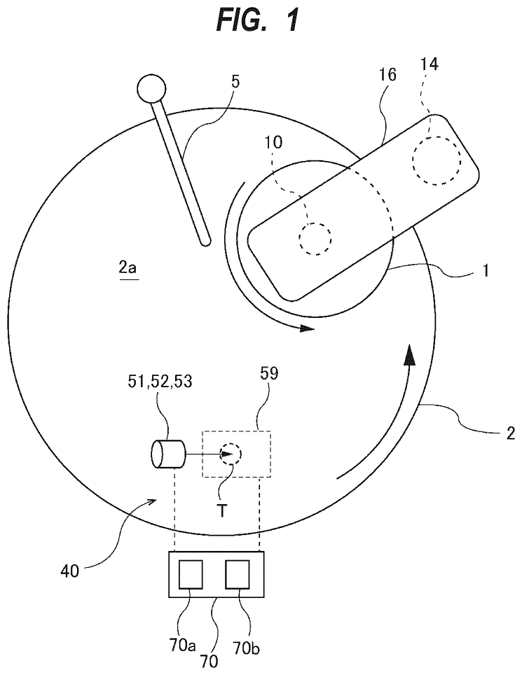

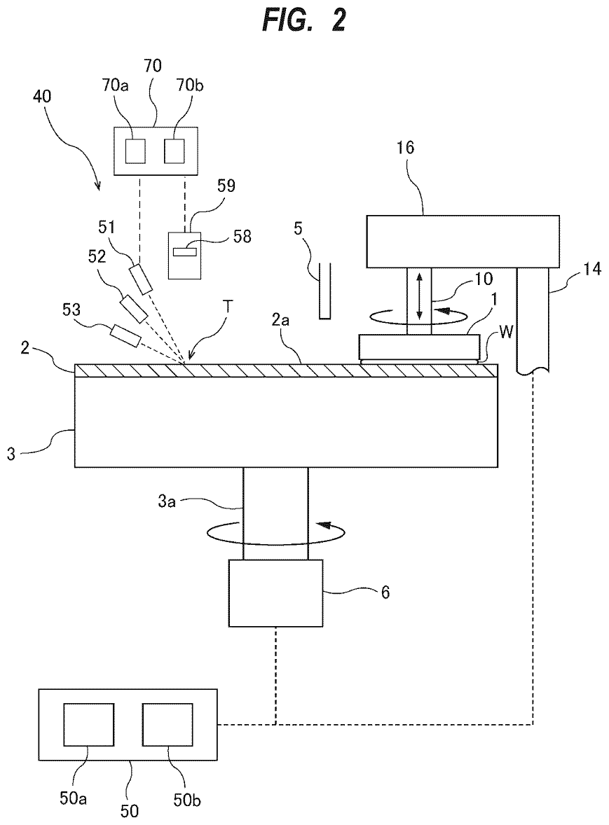

FIG. 1 is a plan view showing an embodiment of a polishing apparatus. FIG. 2 is a side view of the polishing apparatus shown in FIG. 1. The polishing apparatus is a device that chemically and mechanically polishes a substrate W, such as a wafer. As shown in FIGS. 1 and 2, this polishing apparatus includes a polishing table 3 configured to support a polishing pad 2 having a polishing surface 2a, a polishing head 1 configured to press the substrate W against the polishing surface 2a, a polishing-liquid supply nozzle 5 configured to supply a polishing liquid (e.g., a slurry containing abrasive grains) onto the polishing surface 2a, and a pad-surface determination system 40 configured to determine a property of the polishing surface 2a of the polishing pad 2.

The polishing apparatus includes a support shaft 14, a polishing-head oscillation arm 16 coupled to an upper end of the support shaft 14, and a polishing-head shaft 10 rotatably supported by a free end of the polishing-head oscillation arm 16. The polishing head 1 is fixed to a lower end of the polishing-head shaft 10. The polishing head 1 is configured to be able to hold the substrate W on its lower surface. The substrate W is held such that a surface to be polished faces downward.

A polishing-head rotating mechanism (not shown) including an electric motor is disposed within the polishing-head oscillation arm 16. This polishing-head rotating mechanism is coupled to the polishing-head shaft 10 and is configured to rotate the polishing-head shaft 10 and the polishing head 1 about an axis of the polishing-head shaft 10.

The polishing-head shaft 10 is coupled to a polishing-head elevating mechanism (including a ball screw mechanism, for example) which is not shown. This polishing-head elevating mechanism is configured to move the polishing-head shaft 10 up and down relative to the polishing-head oscillation arm 16. This vertical movement of the polishing-head shaft 10 allows the polishing head 1 to move up and down relative to the polishing-head oscillation arm 16 and the polishing table 3.

The polishing apparatus further includes a table motor 6 configured to rotate the polishing table 3 together with the polishing pad 2. The table motor 6 is arranged below the polishing table 3, and the polishing table 3 is coupled to the table motor 6 via a table shaft 3a. The polishing table 3 and the polishing pad 2 are rotated by the table motor 6 about an axis of the table shaft 3a. The polishing pad 2 is attached to an upper surface of the polishing table 3. An exposed surface of the polishing pad 2 constitutes the polishing surface 2a for polishing the substrate W, such as a wafer.

The polishing apparatus further includes a polishing controller 50 configured to control operations of the polishing apparatus. The polishing head 1, the polishing-head rotating mechanism, the polishing-head elevating mechanism, the polishing-liquid supply nozzle 5, the table motor 6, and the pad-surface determination system 40 are electrically coupled to the polishing controller 50, so that operations of the polishing head 1, the polishing-head rotating mechanism, the polishing-head elevating mechanism, the polishing-liquid supply nozzle 5, the table motor 6, and the pad-surface determination system 40 are controlled by the polishing controller 50.

The polishing controller 50 is composed of at least one computer. The polishing controller 50 includes a memory 50a that stores programs for controlling the operations of the polishing apparatus therein, and an arithmetic device 50b configured to execute arithmetic operations according to instructions included in the programs. The memory 50a includes a main memory, such as a random access memory (RAM), and an auxiliary memory, such as a hard disk drive (HDD) or a solid state drive (SSD). Examples of the arithmetic device 50b include a CPU (central processing unit) and a GPU (graphic processing unit). However, the specific configuration of the polishing controller 50 is not limited to these examples.

The substrate W is polished as follows. While the polishing table 3 and polishing head 1 are rotated in directions indicated by arrows in FIGS. 1 and 2, the polishing liquid is supplied from the polishing-liquid supply nozzle 5 onto the polishing surface 2a of the polishing pad 2 on the polishing table 3. The substrate W is rotated by the polishing head 1 and is pressed against the polishing surface 2a of the polishing pad 2 by the polishing head 1 in the presence of the polishing liquid on the polishing pad 2. The surface of the substrate W is polished by a chemical action of the polishing liquid and a mechanical action of the abrasive grains contained in the polishing liquid and/or the polishing pad 2. Thereafter, the substrate W may be water-polished while pure water is supplied onto the polishing pad 2 from a pure-water nozzle (not shown).

After polishing of the substrate W, the substrate W is moved outside the polishing pad 2 and transported to a device that performs the next process. Thereafter, the polishing surface 2a of the polishing pad 2 is dressed by a dresser (not shown). The dresser has hard abrasive grains, such as diamond particles, fixed to its lower surface, and slightly scrapes off the polishing surface 2a of the polishing pad 2, so that the polishing surface 2a of the polishing pad 2 is regenerated.

A plurality of minute protrusions are formed on the polishing surface 2a of the polishing pad 2. The plurality of minute protrusions provide the surface roughness of the polishing pad 2. If the protrusions on the polishing surface 2a become smaller (i.e., if the surface roughness of the polishing pad 2 decreases), a polishing rate of the substrate W may be lowered. Therefore, the polishing apparatus of this embodiment includes a pad-surface determination system 40 configured to determine a surface property of the polishing pad 2. The surface property of the polishing pad 2 includes conditions of the protrusions on the polishing surface 2a.

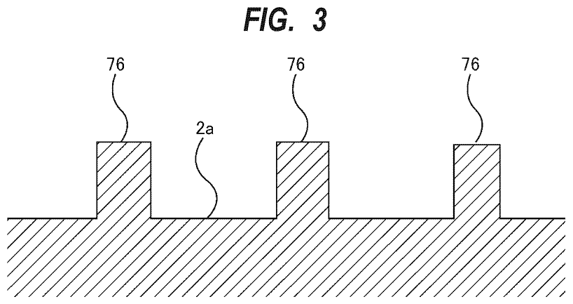

FIG. 3 is a schematic diagram showing an example of protrusions 76 on the polishing surface 2a. The multiple protrusions 76 may be arranged regularly or irregularly. The protrusions 76 on the polishing surface 2a may include not only protrusions of the polishing surface 2a itself, but also foreign matters (abrasive grains, polishing debris, etc.) on the polishing surface 2a. Examples of protrusions on the polishing surface 2a itself include protrusions that constitute an initial surface shape of the polishing pad 2 that has been formed during manufacturing of the polishing pad 2, and minute protrusions formed by diamond particles of a dresser during dressing (conditioning) of the polishing pad 2.

The pad-surface determination system 40 includes a plurality of light emitters 51, 52, 53 configured to irradiate a target area T in the polishing surface 2a of the polishing pad 2 with a plurality of lights at different incident angles, an imaging devices 59 configured to receive a plurality of reflected lights from the target area T and generate a plurality of images from the plurality of reflected lights, and a system processing device 70 configured to determine the surface property of the polishing pad 2 based on at least one of the plurality of images. As described later, the system processing device 70 is configured to generate a pad-surface index value from at least one of the plurality of images corresponding to the different incident angles, and determine the surface property of the polishing pad 2 based on the pad-surface index value.

The system processing device 70 is composed of at least one computer. The system processing device 70 includes a memory 70a that stores a program for determining the property of the polishing surface 2a of the polishing pad 2, and an arithmetic device 70b configured to execute arithmetic operations according to instructions included in the program. The memory 70a includes a main memory, such as a random access memory (RAM), and an auxiliary memory, such as a hard disk drive (HDD) or a solid state drive (SSD). Examples of the arithmetic device 70b include a CPU (central processing unit) and a GPU (graphic processing unit). However, the specific configuration of the system processing device 70 is not limited to these examples.

The plurality of light emitters 51, 52, 53 and the imaging device 59 are arranged above the polishing surface 2a of the polishing pad 2. The plurality of light emitters 51, 52, 53 and the imaging device 59 are fixed to a support member (not shown), and relative positions of the plurality of light emitters 51, 52, 53 and the imaging device 59 with respect to the polishing table 3 and polishing pad 2 are fixed. The system processing device 70 is electrically coupled to the plurality of light emitters 51, 52, 53 and the imaging device 59, so that operations of the plurality of light emitters 51, 52, 53 are controlled by the system processing device 70.

The light emitters 51, 52, 53 include light sources, such as lasers, light-emitting diodes (LEDs), and strobe flash light emitters (e.g., xenon flash lamps). Each of the light emitters 51, 52, 53 may further include, in addition to the light source, an optical element, such as a lens or an optical fiber cable that guides the light generated by the light source to the target area T in the polishing surface 2a.

In this embodiment, the plurality of light emitters 51, 52, and 53 include a first light emitter 51, a second light emitter 52, and a third light emitter 53 arranged along the vertical direction. These light emitters 51, 52, and 53 are installed at different elevation angles with respect to the polishing surface 2a of the polishing pad 2, and are configured to irradiate the polishing surface 2a with lights at different incident angles. In this embodiment, the elevation angle of the first light emitter 51 is larger than the elevation angle of the second light emitter 52, and the elevation angle of the second light emitter 52 is larger than the elevation angle of the third light emitter 53. In one embodiment, only two light emitters may be provided, or four or more light emitters may be provided, as long as the polishing surface 2a can be irradiated with lights at different incident angles.

The plurality of light emitters 51, 52, and 53 emit the lights onto the target area T in the polishing surface 2a at different timings. More specifically, the system processing device 70 instructs the plurality of light emitters 51, 52, and 53 to emit the lights successively (i.e., at different timings). The target area T is a region where the lights emitted by the plurality of light emitters 51, 52, and 53 impinge upon the polishing surface 2a. An arrangement pitch of the protrusions is smaller than a width of the target area T. Therefore, within the target area T there is at least one protrusion described with reference to FIG. 3. Therefore, the light emitted from each of the light emitters 51, 52, and 53 is incident on the protrusion in the target area T.

Grooves and/or holes (not shown) having a predetermined pattern for holding the polishing liquid are formed in the polishing surface 2a of the polishing pad 2. In this embodiment, grooves or holes (collectively referred to as recesses) do not exist in the target area T.

The imaging device 59 includes an image sensor 58. The imaging device 59 is located at a position where the imaging device 59 can receive the reflected light from the target area T including the protrusion. The imaging device 59 may further include an optical element, such as a lens. Examples of the image sensor 58 include a CCD sensor, a CMOS sensor, or the like. The plurality of light emitters 51, 52, 53 and the imaging device 59 face the target area T. The imaging device 59 is arranged above the target area T. The imaging device 59 generates a plurality of images from the plurality of reflected lights from the target area T, and transmits these images to the system processing device 70.

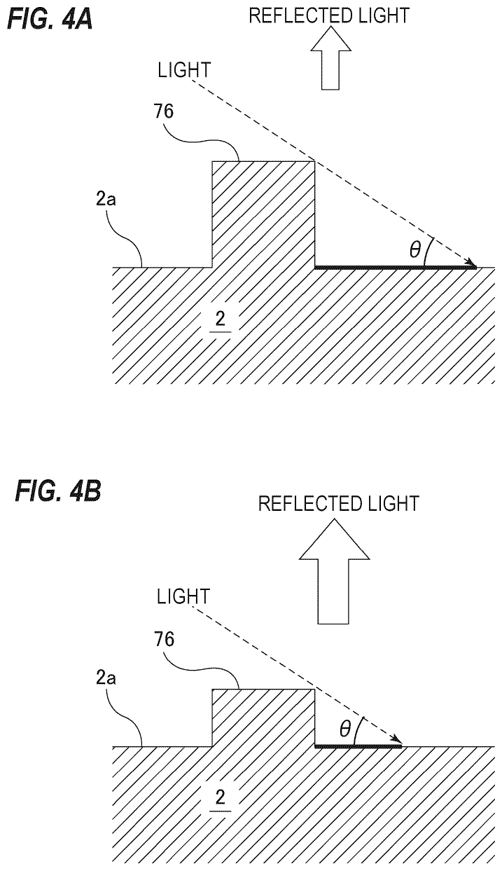

FIGS. 4A and 4B are diagrams illustrating how intensity of the reflected light changes according to a change in height of the protrusion 76 formed on the polishing surface 2a of the polishing pad 2. When the light is incident on the polishing surface 2a of the polishing pad 2 at an incident angle θ, part of the light is blocked by the protrusion 76. As a result, a shadow of the protrusion 76 is cast on the polishing surface 2a. An area of the shadow becomes smaller as the height of the protrusion 76 decreases. As a result, the intensity of the reflected light increases.

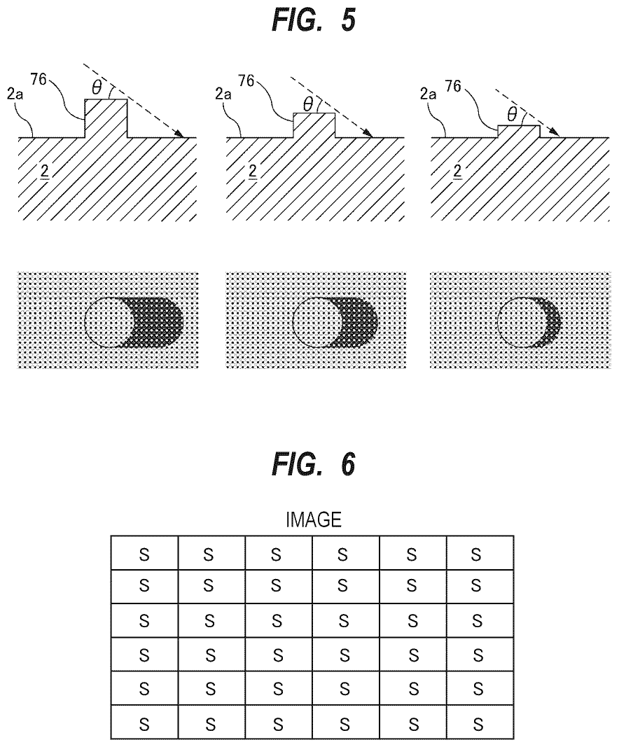

FIG. 5 is a schematic diagram showing an example of images in which the brightness changes according to the change in height of the protrusion 76. A low-brightness area in each image in FIG. 5 corresponds to the shadow of the protrusion 76 on the polishing surface 2a of the polishing pad 2. As shown in FIG. 5, an overall brightness of the image changes according to the change in the height of the protrusion 76.

As described above, as the height of the protrusion 76 changes, i.e., as the property of the polishing surface 2a of the polishing pad 2 changes, the intensity of the reflected light from the target area T including the protrusion 76 changes. The imaging device 59 generates a plurality of images from the plurality of reflected lights corresponding to the plurality of light emitters 51, 52, and 53. The system processing device 70 is configured to generate a pad-surface index value from one of the plurality of images, and generate an alarm signal when the pad-surface index value has changed across a threshold value. The image used to generate the pad-surface index value may be an image generated from reflected light corresponding to one selected in advance from the plurality of light emitters 51, 52, and 53. The image used to generate the pad-surface index value may be an entirety or a part of the original image.

The pad-surface index value is a numerical value calculated based on brightness information of the image. The brightness information of the image may be brightness information of the image on which shading correction is performed to correct the brightness of the image. The brightness information of the image may be brightness information of an image that is cut out (trimmed) from the original image. Furthermore, image filtering (spatial filtering), such as smoothing, for reducing noise may be performed as pre-processing on the image. In one example, the shading correction may be performed on the image, and the resultant image may be then trimmed, or the image filtering may be performed on the image that has been subjected to the shading correction.

Examples of image brightness information include brightness of the entire image, brightness of a part of the image, and brightness distribution in the image. An example of the pad-surface index value calculated based on the brightness information of the image may be a sum or a statistical value (e.g., average, variance, standard deviation) of brightness values of pixels forming the image. In another example, the system processing device 70 may perform image processing on the image to identify the protrusion 76 of the polishing pad 2 in the image, and calculate the pad-surface index value based on brightness of a region including the protrusion 76.

In another example, as shown in FIG. 6, the pad-surface index value may be a variance calculated from a plurality of brightness values of a plurality of segment areas S in the image. The plurality of segment areas S are, for example, grid-like areas predefined within the image. In another example, the segment areas S may have other shape. The variance of the plurality of brightness values of the plurality of segment areas S in the image is determined as follows. First, a representative value, such as a sum or statistical value (e.g., average), of a plurality of brightness values of pixels in each segment area S is calculated, and then a variance of a plurality of representative values calculated for the plurality of segment areas S is calculated. The variance thus calculated is the pad-surface index value for that image.

The variance calculated from the brightness values of the segment areas S in the image represents a clarity of the shadow of the protrusion 76 appearing in the image. More specifically, when the shadow of the protrusion 76 clearly appears in the image (i.e., when the protrusion 76 is high), the variance is large. On the other hand, when the shadow of the protrusion 76 does not clearly appear in the image (i.e., when the protrusion 76 is low), the variance is small. Therefore, the system processing device 70 may generate an alarm signal when the variance as the pad-surface index value is less than a threshold value. In one embodiment, the pad-surface index value may be calculated based on a brightness value of an image on which smoothing has been performed, instead of the above-mentioned variance.

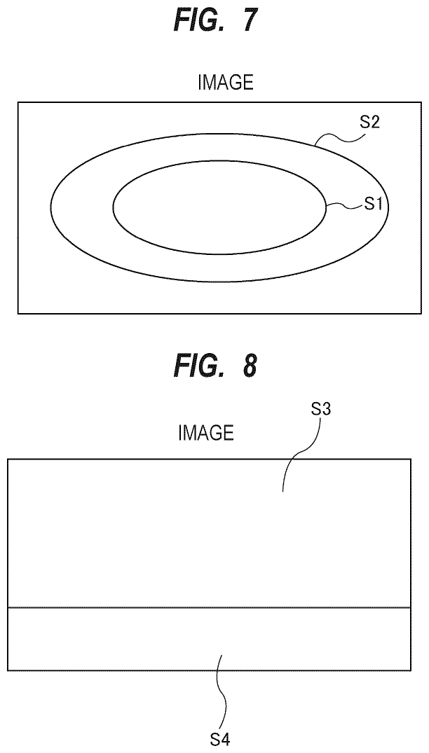

In yet another example, as shown in FIG. 7, the pad-surface index value may be a ratio of a brightness value of a first area S1 to a brightness value of a second area S2 in the image. The first area S1 is an area including the protrusion 76. In the example shown in FIG. 7, the first area S1 is located within the second area S2. In another example, the second area S2 may be located within the first area S1. In yet another example, the first area S1 and the second area S2 may partially overlap. In still other example, the first area S1 and the second area S2 may be separated. The second area S2 may be an area that does not include the protrusion 76. The ratio of the brightness value of the first area S1 to the brightness value of the second area S2 is determined by dividing the brightness value of the first area S1 by the brightness value of the second area S2. Performing such dividing operation can cancel a change over time in quantity of light from the light emitter and can cancel a difference in quantity of light between the multiple light emitters.

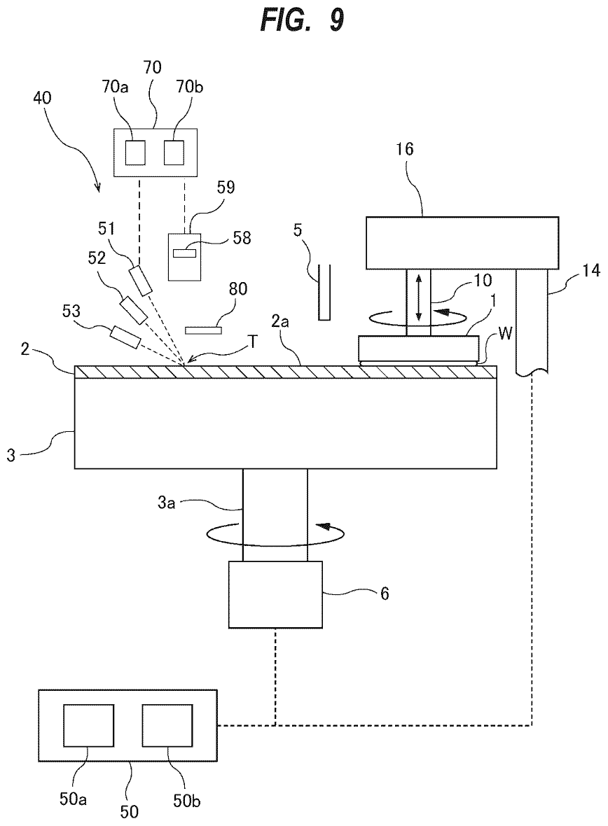

In yet another example, as shown in FIG. 8, the pad-surface index value may be a ratio of a brightness value of a pad area S3 and a brightness value of a reference area S4 in the image. The pad area S3 is an area of the polishing surface 2a of the polishing pad 2 that appears on the image. More specifically, the pad area S3 is an area including the protrusion 76 formed on the polishing surface 2a of the polishing pad 2. The reference area S4 is an area of a reflection plate 80 that appears on the image. The reflection plate 80 will be explained with reference to FIG. 9. FIG. 9 is a side view showing another embodiment of the pad-surface determination system 40. Configurations and operations of this embodiment, which are not particularly described, are the same as those of the above embodiments described with reference to FIGS. 1 and 2, and therefore, redundant explanations thereof will be omitted.

As shown in FIG. 9, the pad-surface determination system 40 includes the reflection plate 80 disposed above the polishing surface 2a of the polishing pad 2. The reflection plate 80 is arranged above the target area T that is irradiated with the lights emitted by the plurality of light emitters 51, 52, and 53. The imaging device 59 is arranged above the target area T and the reflection plate 80 and faces the target area T and the reflection plate 80. As shown in FIG. 8, the imaging device 59 is arranged so as to generate an image including the pad area S3 where the polishing surface 2a of the polishing pad 2 appears in the image and the reference area S4 where the reflector 80 appears in the image.

The system processing device 70 is configured to calculate the pad-surface index value that is the ratio of the brightness value of the pad area S3 to the brightness value of the reference area S4 in the image. The brightness value of the pad area S3 may be a representative value, such as a sum or a statistical value (for example, an average) of a plurality of brightness values of pixels in the pad area S3. Similarly, the brightness value of the reference area S4 may be a representative value, such as a sum or a statistical value (for example, an average) of a plurality of brightness values of pixels in the reference area S4. The ratio of the brightness value of the pad area S3 to the brightness value of the reference area S4 is determined by dividing the brightness value of the pad area S3 by the brightness value of the reference area S4. Performing such dividing operation can cancel a change over time in quantity of light from the light emitter and can cancel a difference in quantity of light between multiple light emitters.

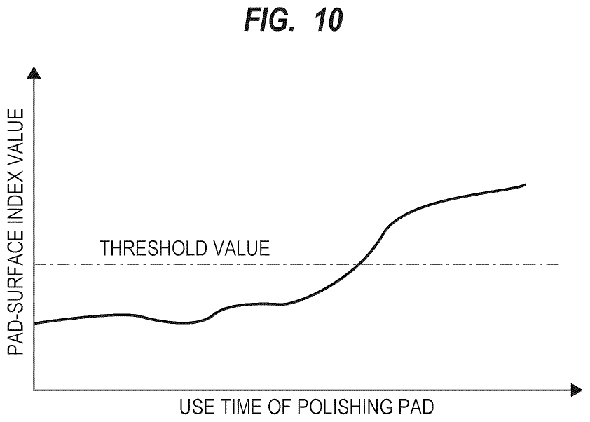

FIG. 10 is a graph showing an example of the pad-surface index value that changes with the use time of the polishing pad 2. In FIG. 10, a vertical axis represents the pad-surface index value, and a horizontal axis represents the use time of the polishing pad 2. In the example shown in FIG. 10, the pad-surface index value increases and exceeds a threshold value as the height of the protrusion 76 decreases. When the pad-surface index value has changed across the threshold value, the system processing device 70 can generate an alarm signal to notify that the polishing pad 2 has reached the end of its service life. Depending on the algorithm for calculating the pad-surface index value, the pad-surface index value may decrease as the height of the protrusion 76 decreases. In that case, the system processing device 70 is configured to generate an alarm signal when the pad-surface index value falls below the threshold value.

In the example shown in FIG. 5, the shadow of the protrusion 76 clearly appears on each image. However, if an exposure time of the light to the image sensor 58 or the light emission time of the light emitter is too long relative to a rotation speed of the polishing table 3, the shadow of the protrusion 76 may not appear clearly in each image. Even in such a case, since the image is generated from the reflected light from the target area T including the shadow of the protrusion 76, the overall brightness information of the image changes according to the height of the protrusion 76.

In the present embodiment, the system processing device 70 is configured to calculate the pad-surface index value based on the brightness information of the image generated from the reflected light corresponding to one selected in advance from the plurality of light emitters 51, 52, 53 and generate an alarm signal when the pad-surface index value changes across a threshold value.

In one embodiment, the system processing device 70 may be configured to calculate a plurality of pad-surface index values based on brightness information of a plurality of images sent from the imaging device 59 and generate an alarm signal when at least one of the plurality of pad-surface index values changes across a threshold value.

The timing of irradiating the target area T with the light and generating an image of the target area T is not particularly limited. In one embodiment, in order to accurately measure the intensity of the reflected light, irradiation of the target area T with the light and generation of an image of the target area T are performed when the polishing liquid, such as slurry, is removed from the polishing pad 2. For example, irradiation of the target area T with the light and generation of an image of the target area T are performed during dressing of the polishing pad 2, which is performed from an end of polishing of a substrate until polishing of the next substrate is started. More specifically, the system processing device 70 instructs the plurality of light emitters 51, 52, and 53 to emit the lights during dressing of the polishing pad 2, and the imaging device 59 receives a plurality of reflected lights from the target area T and generates a plurality of images from the plurality of reflected lights corresponding to the plurality of light emitters 51, 52, and 53. Since the light emitters 51, 52, and 53 emit the lights while the polishing pad 2 is rotating, different areas of the polishing pad 2 are irradiated with the lights.

The height of the protrusion 76 formed on the polishing surface 2a of the polishing pad 2 differs depending on the type of the polishing pad 2. According to this embodiment, the plurality of lights from the plurality of light emitters 51, 52, 53 are directed onto the target area T at different incident angles, so that the pad-surface index value shows a characteristic change according to the height of the protrusion 76, regardless of a type of polishing pad 2 and/or a position in the polishing surface 2a. In order to determine an incident angle of light that can accurately reflect a change in the surface condition of the polishing pad 2 (i.e., a change in the height of the protrusion 76), it is necessary to use a polishing pad from its new condition until the end of its service life for each one of different incident angles. According to this embodiment, since a plurality of images are generated from a plurality of reflected lights corresponding to a plurality of incident angles, there is no need for a step of determining an optimal incident angle in advance.

In one embodiment, the incident angle of the light is selected based on the height and/or arrangement pitch of the protrusions 76 of the polishing pad 2. For example, in a case where the arrangement pitch of the multiple protrusions 76 shown in FIG. 3 is small (i.e., a distance between the multiple protrusions 76 is small), selecting a very small incident angle of light may result in a long shadow of the protrusion 76 that reaches the next protrusion 76. As a result, the pad-surface index value may not accurately reflect the change in height of the protrusions 76. Therefore, in this case, a large incident angle is selected. Conversely, if the arrangement pitch of the multiple protrusions 76 is large, a small incident angle is selected. In another example, as a result of dressing the polishing pad 2, the polishing surface 2a may have an undulate shape and may have fine ridges under some dressing conditions. In that case, relatively heigh ridges are formed, and therefore a large incident angle is desirable. In this way, the incident angle of light is selected so that the pad-surface index value can accurately reflect the change in height of the protrusions 76.

In one embodiment, irradiation of the target area T with the plurality of lights from the plurality of light emitters 51, 52, 53, generation of a plurality of images from the plurality of reflected lights by the imaging device 59, and generation of the pad-surface index value by the system processing device 70 may be repeated within a predetermined period to determine a plurality of pad-surface index values. The system processing device 70 may calculate a variance of the plurality of pad-surface index values and may generate an alarm signal when the variance is larger than a threshold value. Examples of the predetermined period include a period during which a predetermined number of substrates are polished and a period corresponding to one rotation of the polishing table 3.

As the wear of the polishing pad 2 progress, local differences in the height of the protrusion 76 within the polishing surface 2a increase. As a result, the variance of the pad-surface index values obtained within the predetermined period is expected to increase. For example, there is a difference in wear of the polishing pad 2 between a region of the polishing pad 2 that contacts the center of the substrate and a region of the polishing pad 2 that contacts the edge of the substrate. Therefore, the variance of the plurality of pad-surface index values obtained within the predetermined period is expected to increase. The system processing device 70 generates an alarm signal when the variance of the plurality of pad-surface index values is larger than a variance threshold value, and can therefore notify the fact that the polishing pad 2 wears greatly.

In one embodiment, a plurality of pad-surface determination systems 40 may be provided at different positions above the polishing surface 2a of the polishing pad 2. Any one of the plurality of pad-surface determination systems 40 may obtain a plurality of pad-surface index values generated by the plurality of pad-surface determination systems 40, calculate a variance of the plurality of pad-surface index values, and generate an alarm signal when the variance is larger than a variance threshold value. In one embodiment, the pad-surface determination system 40 may move above the polishing pad 2 and may emit the light at different locations to generate a plurality of pad-surface index values.

In the embodiments described above, one imaging device 59 is provided, while a plurality of imaging devices 59 may be provided with different elevation angles corresponding to the plurality of light emitters 51, 52, 53 having different elevation angles.

In one embodiment, irradiation of the target area T with a plurality of lights from the plurality of light emitters 51, 52, 53, and generation of a plurality of images from a plurality of reflected lights from the target area T by the imaging device 59 may be repeated, so that the system processing device 70 can obtain a plurality of time-differential images of a plurality of groups corresponding to the different incident angles. The system processing device 70 is configured to generate a differential image or a division image from a plurality of time-differential images within a group of the same incident angle, and calculate the pad-surface index value based on brightness information of the differential image or division image. The differential image is generated by calculating differences in brightness values between the time-differential images within a group of the same incident angle. The division image is generated by dividing brightness values of a time-differential image by brightness values of another time-differential image within a group of the same incident angle.

Next, another embodiment of the pad-surface determination system 40 will be described. Configurations and operations of this embodiment, which are not particularly described, are the same as those of the embodiments described above with reference to FIGS. 1 to 10, and therefore, redundant explanations thereof will be omitted. In this embodiment, the plurality of light emitters 51, 52, and 53 include a first light emitter 51 that emits a first light having a wavelength within a first wavelength range, a second light emitter 52 that emits a second light having a wavelength within a second wavelength range, and a third light emitter 53 that emits a third light having a wavelength within a third wavelength range. The first wavelength range, the second wavelength range, and the third wavelength range are different from each other.

In one embodiment, the first light, the second light, and the third light have different colors (i.e., different wavelengths). For example, the first light is any one of red light, green light, and blue light, the second light is another one of red light, green light, and blue light, and the third light is the remaining one of red light, green light, and blue light. In one example, the first light has a wavelength of any one of 470 nm, 525 nm, or 625 nm, the second light has a wavelength of another one of 470 nm, 525 nm, or 625 nm, and the third light has a wavelength of the remaining one of 470 nm, 525 nm, and 625 nm.

The system processing device 70 is configured to instruct the first light emitter 51, the second light emitter 52, and the third light emitter 53 to simultaneously emit the first light, the second light, and the third light to the target area T in the polishing surface 2a. Therefore, the first light, the second light, and the third light are superimposed within the target area T.

In one embodiment, the system processing device 70 instructs the first light emitter 51, the second light emitter 52, and the third light emitter 53 to constantly emit the first light, the second light, and the third light, while instructing the imaging device 59 to generate a first image, a second image, and a third image from first reflected light, second reflected light, and third reflected light corresponding to the first light, the second light, and the third light, respectively, at predetermined timing(s) (e.g., at the same time or at different timings).

In the present embodiment, the imaging device 59 includes the image sensor 58 configured to generate the first image, the second image, and the third image simultaneously from the first reflected light, the second reflected light, and the third reflected light corresponding to the first light, the second light, and the third light, respectively. The configuration of the imaging device 59 that generates the three images from the superimposed first reflected light, second reflected light, and third reflected light is not particularly limited.

In one embodiment, the imaging device 59 may include prism that separates the superimposed first reflected light, second reflected light, and third reflected light into the first reflected light, the second reflected light, and the third reflected light, and three image sensors that receive the separated first reflected light, second reflected light, and third reflected light. In another embodiment, the imaging device 59 may include color filter configured to separately extract the first reflected light, the second reflected light, and the third reflected light from the superimposed first reflected light, second reflected light, and third reflected light, and image sensor that receives the first reflected light, the second reflected light, and the third reflected light that have passed through the color filter. In still other embodiment, the imaging device 59 may include an image sensor having three groups of pixels that receive the superimposed first reflected light, second reflected light, and third reflected light, respectively.

The wavelengths of lights emitted at different incident angles are different, and the imaging device 59 can generate an image by selectively receiving light of each wavelength. Therefore, the imaging device 59 can generate multiple images at the same time, and a time required to generate the pad-surface index values can be shortened.

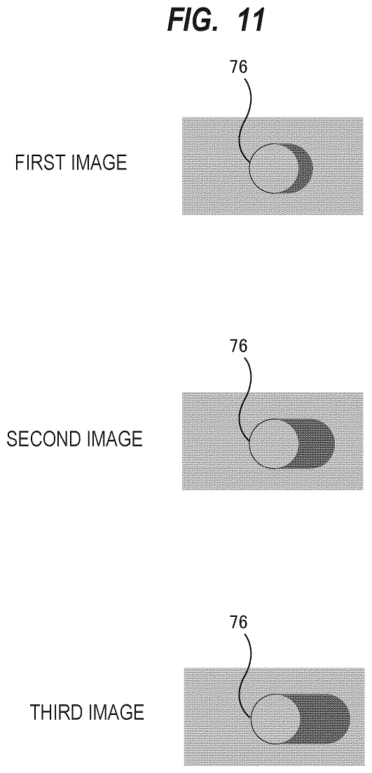

FIG. 11 is a schematic diagram showing an example of three images generated from the first reflected light, the second reflected light, and the third reflected light corresponding to three lights of different incident angles. The three light emitters 51, 52, and 53 simultaneously irradiate the target area T with the first light, the second light, and the third light. The imaging device 59 simultaneously receives the first reflected light, the second reflected light, and the third reflected light from the target area T, and simultaneously generates the first image, the second image, and the third image from the first reflected light, the second reflected light, and the third reflected light. Therefore, as shown in FIG. 11, the protrusion 76 appears at the same position on the first image, the second image, and the third image.

The system processing device 70 is configured to calculate the pad-surface index value based on the brightness information of at least one of the three images generated from the first reflected light, the second reflected light, and the third reflected light. In one embodiment, the system processing device 70 may be configured to calculate the pad-surface index value based on brightness information of an image generated from a reflected light corresponding to one light emitter selected in advance from the plurality of light emitters 51, 52, and 53, and generate an alarm signal when the pad-surface index value changes across a threshold value. In another embodiment, the system processing device 70 may be configured to calculate a plurality of pad-surface index values based on brightness information of a plurality of images sent from the imaging device 59, and generate an alarm signal when at least one of the plurality of pad-surface index values changes across a threshold value.

In one embodiment, the system processing device 70 may generate a differential image or a division image from two of the first image, the second image, and the third image corresponding to the three different incident angles. The pad-surface index value may be calculated based on brightness information of the differential image or the division image. The differential image is generated by calculating differences in brightness values between two of the first image, the second image, and the third image. The division image is generated by dividing brightness values of one of the first image, the second image, and the third image by brightness values of the other.

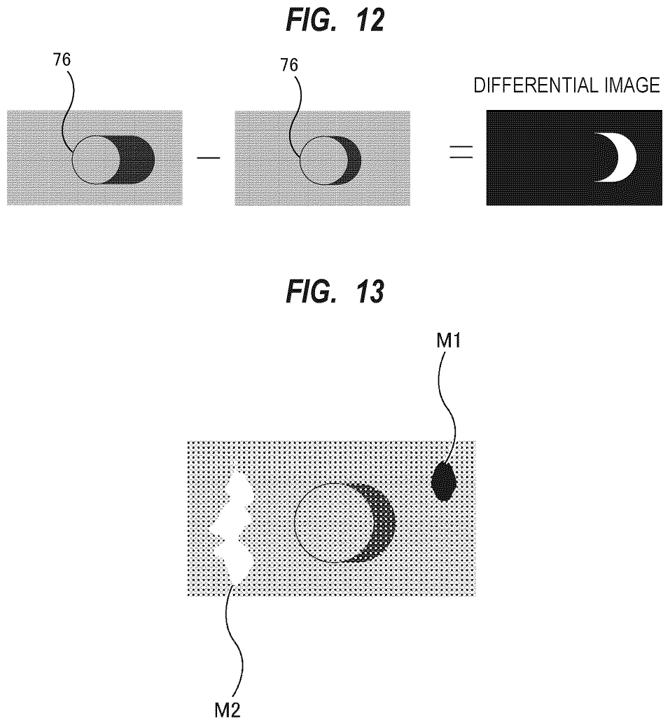

FIG. 12 is a schematic diagram showing an example of the differential image generated from two of the three images shown in FIG. 11. As can be seen from FIG. 12, since the differential image is generated from the two images generated at the same time, noise is removed from the two images and brightness of a portion other than the shadow of the protrusion 76 is canceled. Therefore, the differential image can show a minute change in the brightness of the shadow of the protrusion 76. The system processing device 70 compares the pad-surface index value calculated based on the brightness information of the differential image with a threshold value, and can accurately detect a change in the property of the polishing surface 2a of the polishing pad 2. Although not shown, the division image is also generated in a similar manner. In one embodiment, the system processing device 70 compares the pad-surface index value calculated based on the brightness information of the division image with a threshold value to accurately detect a change in the property of the polishing surface 2a of the polishing pad 2.

In order to cancel brightness of a portion other than the shadow of the protrusion 76, the system processing device 70 may change a density of the image in advance. For example, the system processing device 70 adds or subtracts an offset value to or from brightness values of pixels, or normalizes the brightness values of the pixels. Such density adjustment of the image can correct a difference in the overall intensity of reflected light due to the incident angle and a difference in wavelength sensitivity of the image sensor 58.

In the embodiments described above, the pad-surface determination system 40 uses the three light emitters 51, 52, and 53 to irradiate the target area T with the first light, the second light, and the third light. The imaging device 59 receives the first reflected light, the second reflected light, and the third reflected light from the target area T, and generates a first image, a second image, and a third image from these reflected lights. In one embodiment, the pad-surface determination system 40 may have two light emitters that emit lights at different incident angles, and the imaging device 59 may receive first reflected light and second reflected light from the target area T to generate a first image and a second image from these reflected lights.

If there is a foreign matter, such as dust, on the image sensor 58 of the imaging device 59, a black spot M1 may appear on an image generated by the imaging device 59, as shown in FIG. 13. Furthermore, if there are bubbles in the liquid on the polishing surface 2a of the polishing pad 2, a white pattern M2 may appear on an image generated by the imaging device 59, as shown in FIG. 13. Such black spot M1 and white pattern M2 appear on the image as brightness-deviation regions that have brightness significantly different from other area in the image. The brightness-deviation regions prevent the pad-surface determination system 40 from accurately determining the property of the polishing surface 2a of the polishing pad 2.

Therefore, in one embodiment, the system processing device 70 removes the brightness deviation regions from the image as follows. The system processing device 70 creates an evaluation image, which is either a differential image or a division image, from two images of the plurality of images generated from the reflected lights of the three light emitters 51, 52, and 53, and calculates the pad-surface index value using brightness values within a permissible range among brightness values of pixels constituting the evaluation image. A lower limit of the permissible range is a threshold value for removing a low-brightness area caused by foreign matter (e.g., dust) on the image sensor 58, and an upper limit of the permissible range is a threshold value for removing a high-brightness area caused by foreign matter (e.g., bubbles in the liquid) on the image sensor 58.

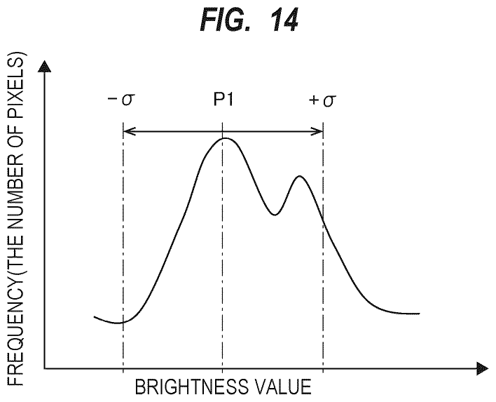

In one embodiment, the permissible range is determined as follows. As shown in FIG. 14, the system processing device 70 creates a frequency distribution of the brightness values of pixels constituting the evaluation image which is either a differential image or a division image, calculates a standard deviation o from the frequency distribution, and determines the permissible range from the standard deviation o. In one embodiment, the system processing device 70 may determine the permissible range with a lower limit of −σ and an upper limit of +σ. In another embodiment, the system processing device 70 may determine the permissible range with a lower limit of −3σ and an upper limit of +3σ. The center of the permissible range is, for example, a brightness value of a peak P1 of the frequency distribution or a median value of the brightness values of the entire evaluation image.

The system processing device 70 calculates the pad-surface index value using the brightness values within the permissible range determined as described above. Examples of the pad-surface index value include a sum or a statistical value (e.g., average, variance, standard deviation) of brightness values within the permissible range. Since the brightness values within the permissible range do not include brightness values of pixels in the brightness deviation region, the pad-surface determination system 40 can accurately determine the property of the polishing surface 2a of the polishing pad 2.

In another embodiment, the system processing device 70 may remove the brightness deviation region from the image according to the same processes described above before generating the evaluation image which is either a differential image or a division image. For example, the system processing device 70 removes brightness values outside the permissible range from brightness values of pixels constituting a first image generated from reflected light of one of the three light emitters 51, 52, and 53 to thereby correct the first image, and generates an evaluation image, which is either a differential image or a division image, from the corrected first image and a second image generated from reflected light of other one of the three light emitters 51, 52, 53.

The permissible range may be determined in the same way as the embodiment described with reference to FIG. 14. Specifically, the system processing device 70 creates a frequency distribution of brightness values of pixels constituting the first image, calculates a standard deviation from the frequency distribution, and determines the permissible range from the standard deviation. The center of the permissible range is, for example, a brightness value of a peak of the frequency distribution of the first image or a median value of the entire brightness values of the first image.

The system processing device 70 calculates the pad-surface index value using the brightness values of pixels constituting the evaluation image generated from the corrected first image and the second image. Examples of the pad-surface index values include a sum or a statistical value (e.g., average, variance, standard deviation) of brightness values of pixels constituting the evaluation image. Since the brightness values of pixels constituting the evaluation image do not include brightness values of pixels in the brightness deviation region, the pad-surface determination system 40 can accurately determine the property of the polishing surface 2a of the polishing pad 2.

In one embodiment, the system processing device 70 may correct the second image by removing brightness deviation region from the second image before generating the evaluation image, as well as the first image. Specifically, the system processing device 70 corrects the second image by removing brightness values outside the permissible range from brightness values of pixels constituting the second image. The system processing device 70 generates an evaluation image, which is either a differential image or a division image, from the corrected first image and the corrected second image, and calculates the pad-surface index value using brightness values of pixels constituting the evaluation image.

The permissible range used to correct the second image may be determined in the same way as the embodiment described with reference to FIG. 14. Specifically, the system processing device 70 creates a frequency distribution of brightness values of pixels constituting the second image, calculates a standard deviation from the frequency distribution, and determines a permissible range from the standard deviation. The center of the permissible range is, for example, a brightness value of a peak of the frequency distribution of the second image, or a median value of the entire brightness values of the second image.

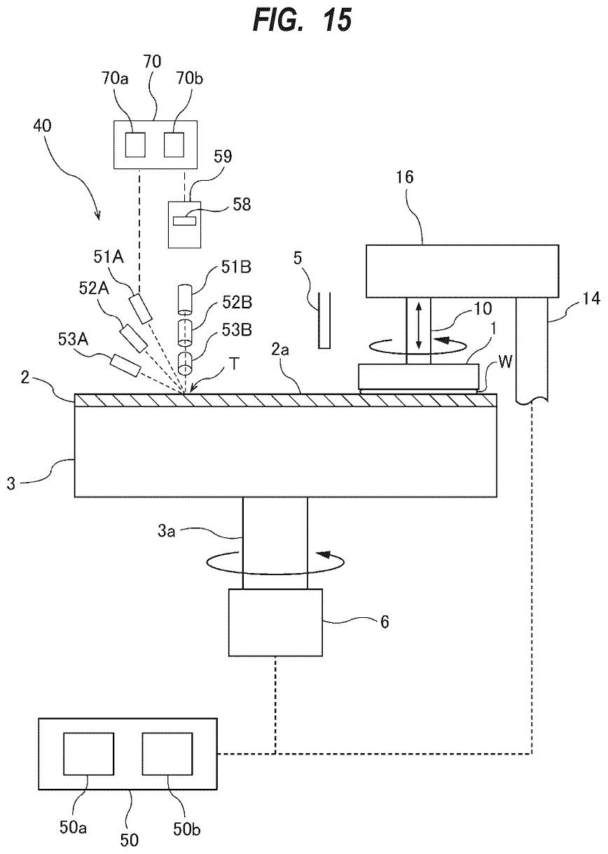

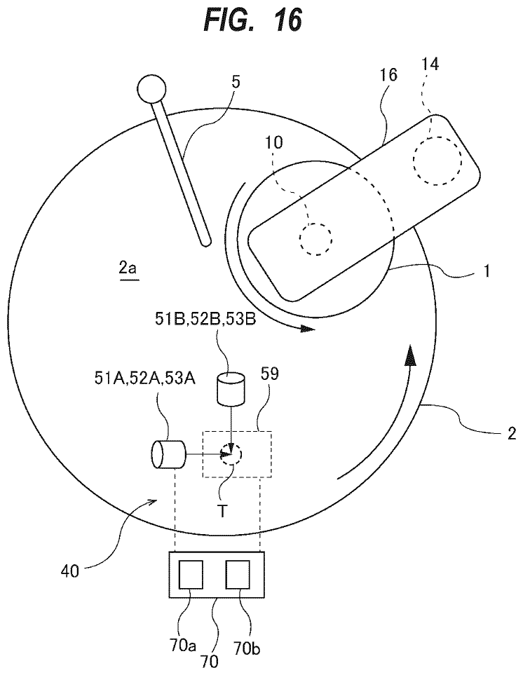

Next, still another embodiment of the pad-surface determination system 40 will be described with reference to FIGS. 15 and 16. FIG. 15 is a side view showing still another embodiment of the pad-surface determination system 40, and FIG. 16 is a plan view of the pad-surface determination system 40 shown in FIG. 15. Configurations and operations of this embodiment, which are not particularly described, are the same as those of the embodiments described above with reference to FIGS. 1 to 12, and therefore, redundant explanations thereof will be omitted. In this embodiment, as shown in FIG. 16, a plurality of light emitters include a first set of light emitters 51A, 52A, and 53A arranged in a first direction from the target area T as viewed from a direction perpendicular to the polishing surface 2a of the polishing pad 2, and a second set of light emitters 51B, 52B, and 53B arranged in a second direction from the target area T as viewed from the direction perpendicular to the polishing surface 2a of the polishing pad 2.

The first direction and the second direction intersect with each other when viewed from the direction perpendicular to the polishing surface 2a of the polishing pad 2. In the embodiment shown in FIGS. 15 and 16, when viewed from the direction perpendicular to the polishing surface 2a of the polishing pad 2, the first direction and the second direction are perpendicular to each other. The first direction is perpendicular to a radial direction of the polishing pad 2, and the second direction is the radial direction of the polishing pad 2. However, the first direction and the second direction are not limited to the present embodiment as long as the first direction and the second direction intersect with each other as viewed from the direction perpendicular to the polishing surface 2a of the polishing pad 2.

The plurality of light emitters 51A, 52A, and 53A of the first set are arranged at different elevation angles with respect to the polishing surface 2a, and are configured to emit first lights at different incident angles to the target area T in the polishing surface 2a. Each of the light emitters 51A, 52A, 53A is configured to emit the first light having a wavelength within a first wavelength range. The plurality of light emitters 51B, 52B, and 53B of the second set are also arranged at different elevation angles with respect to the polishing surface 2a, and are configured to emit the second lights at different incident angles to the target area T in the polishing surface 2a. Each of the light emitters 51B, 52B, 53B is configured to emit the second light having a wavelength within a second wavelength range. The first wavelength range and the second wavelength range are different from each other.

In one embodiment, the first light and the second light have different colors (i.e., different wavelengths). For example, the first light is one of red light, green light, and blue light, and the second light is other one of red light, green light, and blue light.

The system processing device 70 is configured to synchronize the first set of multiple light emitters 51A, 52A, 53A and the second set of multiple light emitters 51B, 52B, 53B to cause them to emit lights sequentially. More specifically, the system processing device 70 instructs the first light emitter 51A of the first set and the first light emitter 51B of the second set to emit first light and second light simultaneously at the same incident angle, then instructs the second light emitter 52A of the first set and the second light emitter 52B of the second set to simultaneously emit first light and second light at the same incident angle, and then instructs the third light emitter 53A of the first set and the third light emitter 53B of the second set to simultaneously emit first light and second light at the same incident angle. The first lights and the second lights at three different incident angles are emitted sequentially.

In one embodiment, the system processing device 70 may be configured to instruct the first set of light emitters 51A, 52A, 53A and the second set of light emitters 51B, 52B, 53B to constantly emit the lights while instructing the imaging device 59 to generate a plurality of images at predetermined timing(s) (for example, at the same time or at different timings) from a plurality of reflected lights corresponding to the plurality of lights emitted by the light emitters 51A, 52A, 53A, 51B, 52B, and 53B.

The imaging device 59 is arranged at a position where the imaging device 59 can receive first reflected lights and second reflected lights from the target area T corresponding to the first lights and second lights emitted by the first set of multiple light emitters 51A, 52A, 53A and the second set of multiple light emitters 51B, 52B, 53B. The imaging device 59 is configured to simultaneously generate two images from first reflected light and second reflected light corresponding to the first light and the second light at the same incident angle. The specific configuration of the imaging device 59 is the same as that in the embodiments already described, and redundant explanations thereof will be omitted.

In one embodiment, the system processing device 70 is configured to obtain from the imaging device 59 two images generated from two reflected lights corresponding to the first light and the second light at the same incident angle, generate a differential image or a division image from the two images, calculate the pad-surface index value based on the brightness information of the differential image or division image, and generate an alarm signal when the pad-surface index value has changed across a threshold value.

The first set of multiple light emitters 51A, 52A, 53A and the second set of multiple light emitters 51B, 52B, 53B can irradiate the target area T with lights from different directions. Such arrangement of the light emitters can eliminate an influence of uneven distribution of the protrusions 76 on the polishing surface 2a of the polishing pad 2, and can also reduce an influence of directions of arrangement patterns of the protrusions 76 of the polishing pad 2. The system processing device 70 can accurately detect a change in the surface property of the polishing pad 2 based on the pad-surface index value.

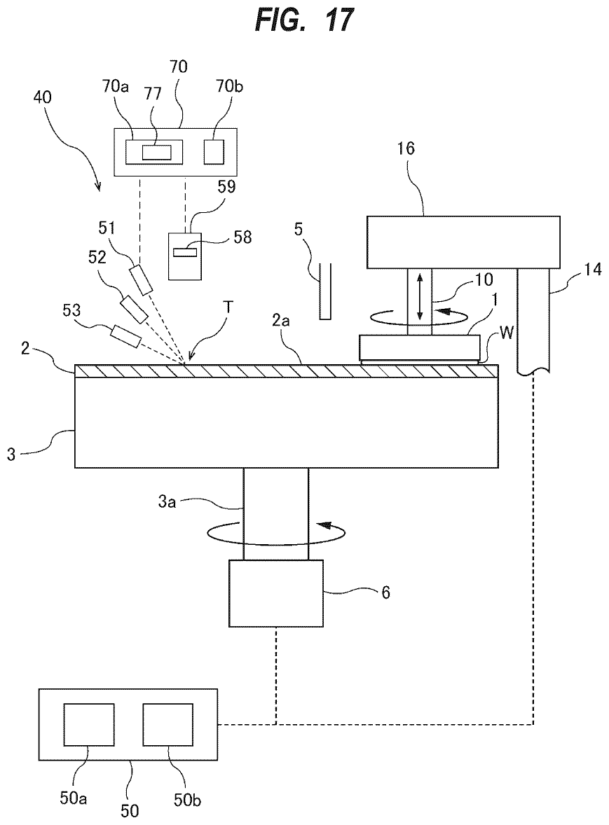

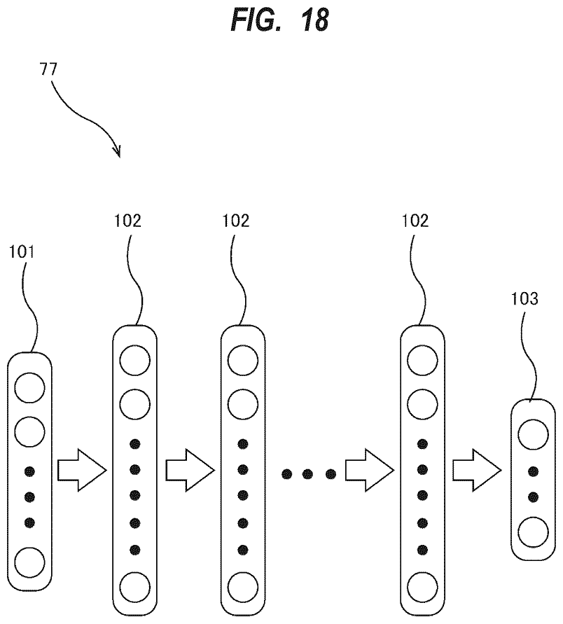

Next, yet another embodiment of the pad-surface determination system 40 will be described with reference to FIGS. 17 and 18. In this embodiment, the system processing device 70 is configured to input at least one of a plurality of images generated by the imaging device 59 into a determination model 77 constructed by machine learning, and output a determination result of the surface property of the polishing pad 2 from the determination model 77. Irradiation of the target area T with light and generation of an image of the target area T are performed from the end of polishing of the substrate until polishing of the next substrate is started. For example, irradiation of the target area T with light and generation of an image of the target area T are performed during dressing of the polishing pad 2.

The system processing device 70 has the determination model 77 stored in its memory 70a. This determination model 77 is a trained model constructed by machine learning. Examples of the machine learning include SVR (support vector regression), PLS (partial least squares), deep learning, random forest, and decision tree method. In one example, the determination model 77 is constituted of a neural network constructed by a deep learning method.

Training data used for the machine learning of the determination model 77 includes images of polishing surface of polishing pad, and further includes surface properties (which are ground-truth labels or correct labels) corresponding to the images of the polishing surface of the polishing pad. Each surface property is a numerical value indicating a degree of surface property of polishing pad, and can be expressed in a predetermined manner, such as 0 or 1, a percentage of 0 to 100%, a numerical value from 1 to 10, or a level of 1 to 5.

For example, an image of a polishing surface of a polishing pad generated when a working person determines that the polishing pad has reached the time to replace it is associated with 0 as a corresponding ground-truth label. An image of a polishing surface of a polishing pad generated when the working person determines that the polishing pad has not yet reached the time to replace it is associated with 1 as a corresponding ground-truth label. Whether or not a polishing pad has reached the time to be replaced is determined based on factors, such as a decrease in a polishing rate and an amount of wear of the polishing pad.

In another example, when a surface property as the ground-truth label is expressed as a percentage of 0 to 100%, a surface property of 0% indicates that a polishing pad is new, and a surface property of 100% indicates that a polishing pad has reached a time for replacement. An image generated when the working person determines that the polishing pad has reached a time for replacement is associated with 100% as the corresponding ground-truth label. If the number of polished substrates is 1000 when the replacement time is reached (i.e., if the number of polished substrates corresponding to 100% of the ground-truth label is 1000), an image of a polishing surface generated when the number of polished substrates is 900 is associated with 90% as a corresponding ground-truth label. An image of a polishing surface generated when the number of polished substrates is 800 is associated with 80% as a corresponding ground-truth label. A ground-truth label corresponding to an image of a polishing surface of a polishing pad in an intermediate condition is determined in the same way. In this manner, the training data including ground-truth labels 0 to 100% and a plurality of images corresponding to these ground-truth labels is obtained.

In the embodiment shown in FIG. 17, the plurality of light emitters 51, 52, 53 are provided with the plurality of different incident angles. A plurality of training data may be created corresponding to the plurality of different incident angles. A plurality of determination models corresponding to the plurality of training data (i.e., corresponding to the plurality of different incident angles) may be created by machine learning. In one embodiment, one determination model may be created by machine learning using a plurality of training data corresponding to the plurality of different incident angles. In another embodiment, one determination model may be created by machine learning using one training data including a plurality of images generated from a plurality of reflected lights corresponding to the multiple different incident angles.

In one embodiment, a differential image or a division image may be created from a plurality of images generated from a plurality of reflected lights corresponding to the plurality of different incident angles. In this embodiment, training data including the differential image or division image is created, and a determination model is created by machine learning using the training data. For example, a differential image or a division image is created from a first image corresponding to the first incident angle and a second image corresponding to the second incident angle, and the training data containing the differential image or division image is created. Then, a determination model is created by machine learning using the training data. In this case, a differential image or a division image is input to the determination model (which is a trained model) constructed by the machine learning, as well as the training data.

In one embodiment, a first determination model may be created by machine learning using training data that includes a differential image or a division image created from a first image corresponding to the first incident angle and a second image corresponding to the second incident angle, and further a second determination model may be created by machine learning using training data that includes a differential image or a division image created from the second image corresponding to the second incident angle and a third image corresponding to the third incident angle.

FIG. 18 is a schematic diagram showing an example of the determination model 77 constructed using a deep learning method. The determination model 77 has an input layer 101, a plurality of hidden layers (also referred to as intermediate layers) 102, and an output layer 103. An image is input to the input layer 101, and a determination result of a surface property of a polishing pad is output from the output layer 103. The determination result of the surface property of the polishing pad output from the output layer 103 is, for example, a numerical value or a combination of a plurality of numerical values indicating the surface property of the polishing pad.

The construction of the determination model 77 using the deep learning method is performed as follows. An image of a polishing surface of a polishing pad included in the training data is input to the input layer 101 shown in FIG. 18. The determination model 77 is configured such that when an image is input to the input layer 101, a numerical value indicating the surface property of the polishing pad corresponding to the image is output from the output layer 103. In the machine learning for constructing the determination model 77, the system processing device 70 compares the numerical value indicating the surface property output from the output layer 103 with a ground-truth label corresponding to the input image, and adjusts parameters (weights, threshold values, etc.) of respective nodes (neurons) so as to minimize an error between the numerical value output from the output layer 103 and the corresponding ground-truth label. In this way, the determination model 77 is trained to output an appropriate determination result of a surface property from the output layer 103 based on an image input to the input layer 101. The determination model 77 may be configured to output a confidence score of the determination result together with the determination result of the surface property of the polishing pad.

In one embodiment, the determination of the surface property of the polishing pad 2 using the determination model 77 is performed as follows. The imaging device 59 generates a first image, a second image, and a third image from first reflected light, second reflected light, and third reflected light that correspond to the first light, the second light, and the third light at different incident angles. The system processing device 70 inputs one of the first image, the second image, and the third image to the determination model 77, and outputs the determination result of the surface property of the polishing pad 2 from the determination model 77.

In another embodiment, the system processing device 70 may have a plurality of determination models 77 corresponding to the different incident angles. In this embodiment, the system processing device 70 inputs a plurality of images corresponding to the different incident angles to the plurality of determination models 77, respectively, and outputs a plurality of determination results of the surface property of the polishing pad 2 from the plurality of determination models 77. When at least one of the plurality of determination results indicates that the polishing pad 2 has reached the end of its service life, the polishing pad 2 is replaced with a new polishing pad.

In yet another embodiment, the system processing device 70 creates a differential image or a division image from two of the plurality of images corresponding to the different incident angles, inputs the differential image or division image to the determination model 77, and outputs the determination result of the surface property of the polishing pad 2 from the determination model 77.

According to these embodiments, the surface property of the polishing pad 2 can be monitored based on the determination result of the surface property output from the determination model(s). For example, when the output surface property is 50%, it can be determined that the current surface property of the polishing pad 2 is half of the surface property at the time of replacement of the polishing pad 2.

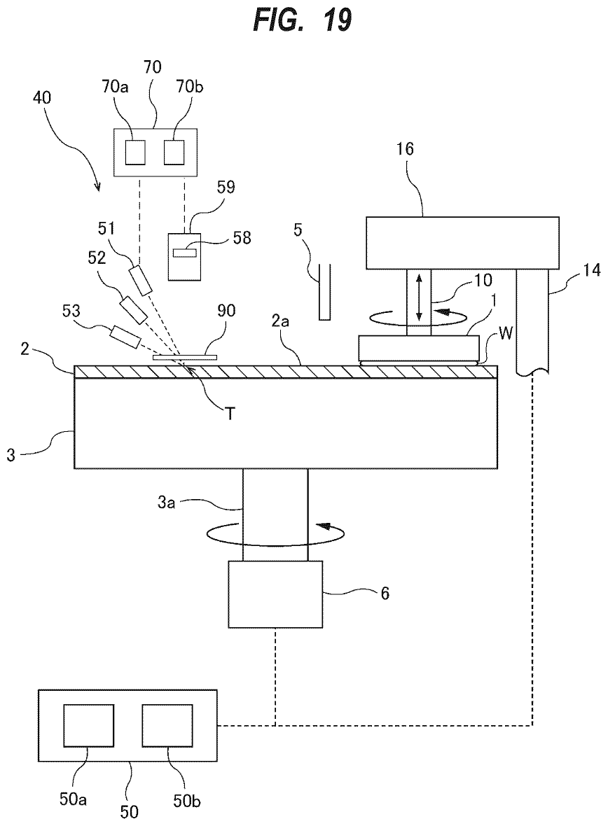

FIG. 19 is a side view showing yet another embodiment of the pad-surface determination system 40. Configurations and operations of this embodiment, which are not particularly described, are the same as those of the above embodiments described with reference to FIGS. 1 and 2, and therefore, redundant explanations thereof will be omitted. As shown in FIG. 19, the pad-surface determination system 40 of this embodiment includes a filter 90 arranged between the plurality of light emitters 51, 52, 53 and the polishing surface 2a.

The filter 90 is located directly above the target area T in the polishing surface 2a. The filter 90 is held by a filter holder (not shown), and the position of the filter 90 is fixed. The filter 90 is configured to allow a plurality of lights emitted from the plurality of light emitters 51, 52, 53 to pass therethrough, while not allowing passage of a light traveling from a direction different from the direction of the lights of the plurality of light emitters 51, 52, 53 as viewed from a direction perpendicular to the polishing surface 2a. The lights emitted by the plurality of light emitters 51, 52, and 53 pass through the filter 90 and reaches the target area T in the polishing surface 2a.

The imaging device 59 is arranged above the target area T and the filter 90, and faces the target area T and the filter 90. The imaging device 59 generates an image from the reflected light that has passed through the filter 90.

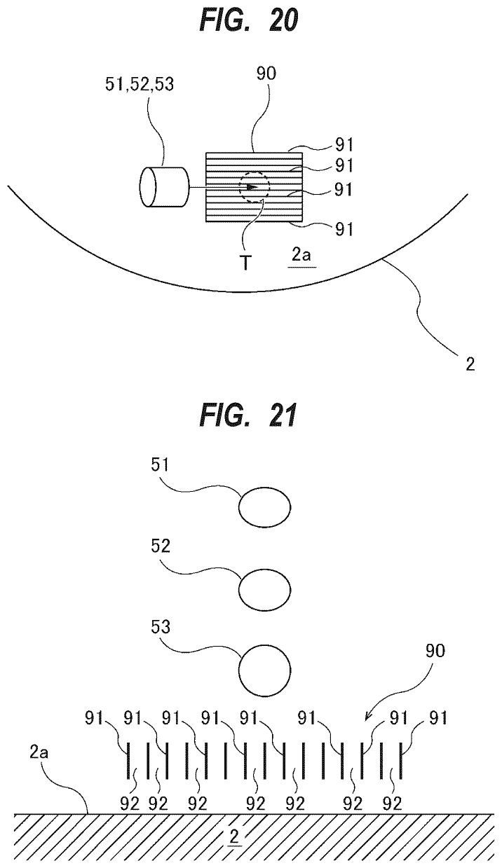

FIG. 20 is a plan view showing an embodiment of the plurality of light emitters 51, 52, 53 and the filter 90 as viewed from a direction perpendicular to the polishing surface 2a. As shown in FIG. 20, the filter 90 has a plurality of light-blocking walls 91 extending parallel to an orientation of the plurality of light emitters 51, 52, and 53 as viewed from the direction perpendicular to the polishing surface 2a. Specifically, as viewed from the direction perpendicular to the polishing surface 2a, a longitudinal direction of the plurality of light-blocking walls 91 is parallel to the orientation of the plurality of light emitters 51, 52, and 53. The orientation of the plurality of light emitters 51, 52, 53 is a direction of an optical axis of the light emitted from each of the plurality of light emitters 51, 52, 53. Each light-blocking wall 91 is made of a material that does not allow light to pass therethrough. In one embodiment, the plurality of light-blocking walls 91 are a plurality of louvers or a plurality of plates that extend parallel to the orientation of the plurality of light emitters 51, 52, 53 as viewed from the direction perpendicular to the polishing surface 2a.

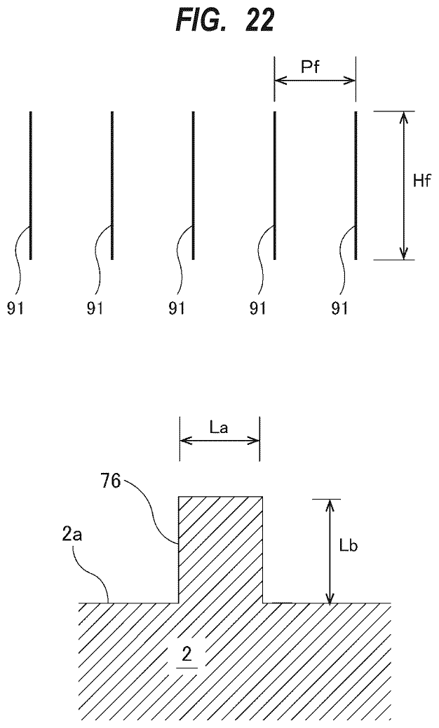

FIG. 21 is a front view showing one embodiment of the plurality of light emitters 51, 52, 53 and the filter 90 shown in FIG. 20. As shown in FIG. 21, both side surfaces of each light-blocking wall 91 are perpendicular to the polishing surface 2a. The plurality of light-blocking walls 91 are arranged at intervals. The plurality of lights emitted from the plurality of light emitters 51, 52, and 53 reach the polishing surface 2a of the polishing pad 2 through optical paths 92 formed between the plurality of light-blocking walls 91. In this embodiment, the optical paths 92 are spaces between the light-blocking walls 91. In one embodiment, light-transmitting material, such as glass or transparent resin, may be disposed between the plurality of light-blocking walls 91.

FIG. 22 is a diagram illustrating an embodiment of a pitch and a height of the light-blocking walls 91 of the filter 90. If a pitch Pf of the light-blocking walls 91 is too large, the filter 90 cannot block light obliquely incident on the light-blocking walls 91 as viewed from the direction perpendicular to the polishing surface 2a. Similarly, if a height Hf of the light-blocking walls 91 is too low, the filter 90 cannot block light obliquely incident on the light-blocking walls 91 as viewed from the direction perpendicular to the polishing surface 2a.

Therefore, in one embodiment, as shown in FIG. 22, a ratio (Hf/Pf) of the height Hf to the pitch Pf of the light-blocking walls 91 is not less than the aspect ratio Lb/La of the protrusion 76. The pitch Pf is a distance between adjacent two of the light-blocking walls 91. La represents the width of the protrusion 76, and Lb represents the height of the protrusion 76. The filter 90 having the light-blocking walls 91 of such dimensions can block light obliquely incident on the light-blocking walls 91.

Light from a light emitter other than the plurality of light emitters 51, 52, and 53 may be unwanted noise for determining the surface property of the polishing pad 2. The filter 90 allows the plurality of lights emitted from the light emitters 51, 52, and 53 to pass therethrough, while not allowing passage of light from a direction (e.g., diagonally, perpendicularly) that is different from the direction of the lights from the light emitters 51, 52, and 53 as viewed from the direction perpendicular to the polishing surface 2a. Furthermore, the filter 90 can convert the plurality of lights emitted from the plurality of light emitters 51, 52, and 53 into collimated light. As a result, the system processing device 70 can accurately determine the surface property of the polishing pad 2 based on at least one of the plurality of images corresponding to the plurality of lights emitted by the plurality of light emitters 51, 52, and 53.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

What is claimed is:

1. A pad-surface determination method of determining a surface property of a polishing pad having a polishing surface for polishing a substrate, comprising:
irradiating a target area in the polishing surface with a plurality of lights from a plurality of light emitters at different incident angles, a protrusion being formed on the polishing surface in the target area;
receiving a plurality of reflected lights from the target area by an imaging device;
generating a plurality of images corresponding to the different incident angles by the imaging device; and
determining the surface property of the polishing pad based on at least one of the plurality of images.

2. The pad-surface determination method according to claim 1, wherein determining the surface property of the polishing pad comprises generating a pad-surface index value from the at least one image.

3. The pad-surface determination method according to claim 2, wherein the pad-surface index value is calculated based on brightness information of an image.

4. The pad-surface determination method according to claim 3, wherein generating the pad-surface index value from the at least one image comprises:
creating a differential image or division image from the plurality of images; and
calculating the pad-surface index value based on brightness information of the differential image or division image.

5. The pad-surface determination method according to claim 1, wherein the plurality of lights from the plurality of light emitters include a first light having a wavelength within a first wavelength range emitted from a first light emitter, and a second light having a wavelength within a second wavelength range emitted from a second light emitter, and the first wavelength range is different from the second wavelength range.

6. The pad-surface determination method according to claim 5, wherein the first light emitter and the second light emitter simultaneously irradiate the target area with the first light and the second light at the different incident angles.

7. The pad-surface determination method according to claim 5, wherein the plurality of images corresponding to the different incident angles are simultaneously generated by the imaging device.

8. The pad-surface determination method according to claim 2, further comprising repeating irradiation of the target area with the plurality of lights and generation of the plurality of images from the plurality of reflected lights by the imaging device to obtain a plurality of time-differential images of a plurality of groups corresponding to the different incident angles,
wherein generating the pad-surface index value comprises generating a differential image or division image from a plurality of time-differential images within a group of the same incident angle, and calculating the pad-surface index value based on brightness information of the differential image or division image.

9. The pad-surface determination method according to claim 2, further comprising:
repeating irradiation of the target area with the plurality of lights, generation of the plurality of images from the plurality of reflected lights by the imaging device, and generation of the pad-surface index value to obtain a plurality of pad-surface index values; and
calculating a variance of the plurality of pad-surface index values.

10. The pad-surface determination method according to claim 1, wherein determining the surface property of the polishing pad based on the at least one image comprises:
inputting the at least one image into a determination model constructed by machine learning; and
outputting a determination result of the surface property of the polishing pad from the determination model.

11. The pad-surface determination method according to claim 2, wherein generating the pad-surface index value from the at least one image comprises:
creating an evaluation image which is either a differential image or a division image from the plurality of images; and
calculating the pad-surface index value using brightness values within a permissible range among brightness values of pixels constituting the evaluation image.

12. The pad-surface determination method according to claim 11, further comprising:
creating a frequency distribution of brightness values of pixels constituting the evaluation image;
calculating a standard deviation from the frequency distribution; and
determining the permissible range from the standard deviation.

13. The pad-surface determination method according to claim 2, wherein generating the pad-surface index value from the at least one image comprises:
correcting the at least one image by removing brightness values outside a permissible range from brightness values of pixels constituting the at least one image;
generating an evaluation image, which is either a differential image or a division image, from the plurality of images including the corrected image; and
calculating the pad-surface index value using brightness values of pixels constituting the evaluation image.

14. A pad-surface determination system for determining a surface property of a polishing pad having a polishing surface for polishing a substrate, comprising:
a plurality of light emitters configured to irradiate a target area in the polishing surface with a plurality of lights at different incident angles, a protrusion being formed on the polishing surface in the target area;
an imaging device configured to receive a plurality of reflected lights from the target area and generates a plurality of images from the plurality of reflected lights; and
a system processing device configured to determine the surface property of the polishing pad based on at least one of the plurality of images.

15. The pad-surface determination system according to claim 14, wherein the system processing device is configured to generate a pad-surface index value from the at least one image.

16. The pad-surface determination system according to claim 15, wherein the pad-surface index value is calculated based on brightness information of an image.

17. The pad-surface determination system according to claim 16, wherein the system processing device is configured to create a differential image or a division image from the plurality of images, and calculate the pad-surface index value based on brightness information of the differential image or the division image.

18. The pad-surface determination system according to claim 14, wherein the plurality of light emitters include a first light emitter configured to emit a first light having a wavelength within a first wavelength range, and a second light emitter configured to emit a second light having a wavelength within a second wavelength range, the first wavelength range being different from the second wavelength range.

19. The pad-surface determination system according to claim 18, wherein the system processing device is configured to instruct the first light emitter and the second light emitter to simultaneously irradiate the target area with the first light and the second light.

20. The pad-surface determination system according to claim 18, wherein the imaging device is configured to simultaneously generate the plurality of images from first reflected light and second reflected light corresponding to the first light and the second light, respectively.

21. The pad-surface determination system according to claim 14, wherein the plurality of light emitters include a first set of light emitters and a second set of light emitters, the first set of light emitters being located in a first direction from the target area as viewed from a direction perpendicular to the polishing surface of the polishing pad, and the second set of light emitters being located in a second direction from the target area as viewed from the direction perpendicular to the polishing surface of the polishing pad.

22. The pad-surface determination system according to claim 14, wherein the system processing device is configured to input the at least one image into a determination model constructed by machine learning, and output a determination result of the surface property of the polishing pad from the determination model.

23. The pad-surface determination system according to claim 15, wherein the system processing device is configured to:
create an evaluation image which is either a differential image or a division image from the plurality of images; and
calculate the pad-surface index value using brightness values within a permissible range among brightness values of pixels constituting the evaluation image.

24. The pad-surface determination system according to claim 23, wherein the system processing device is configured to:
create a frequency distribution of brightness values of pixels constituting the evaluation image;
calculate a standard deviation from the frequency distribution; and
determine the permissible range from the standard deviation.

25. The pad-surface determination system according to claim 15, wherein the system processing device is configured to:
correct the at least one image by removing brightness values outside a permissible range from brightness values of pixels constituting the at least one image;
generate an evaluation image, which is either a differential image or a division image, from the plurality of images including the corrected image; and
calculate the pad-surface index value using brightness values of pixels constituting the evaluation image.
